(19) United States
(12) Patent Application Publication
(10) Pub. No.: US 2007/0299201 A1
(43) Pub. Date: Dec. 27, 2007

(54) Process for manufacturing hydrogels

(75) Inventor: Jan Lovy, Rocky Hill, NJ (US)

Correspondence Address: CARTER, DELUCA, FARRELL & SCHMIDT, LLP, 445 BROAD HOLLOW ROAD, SUITE 225, MELVILLE, NY, 11747, US

(73) Assignee: Replication Medical, Inc.

(21) Appl. No.: 11/821,039

(22) Filed: Jun. 21, 2007

Related U.S. Application Data
(60) Provisional application No. 60/816,145, filed on Jun. 23, 2006.

(51) Int. Cl. C08F 8/30

(52) U.S. Cl. 524/555; 525/329.1

(57) ABSTRACT

An improved method of making a PAN copolymer is provided which includes providing a first reaction mixture including polyacrylonitrile dissolved in an aqueous solution containing a thiocyanate salt; providing a second reaction mixture including a metal catalyst dissolved in an aqueous reactive solvent; mixing the first and second reaction mixtures in a container to form a master reaction mixture; heating the master reaction mixture via a heating element to maintain a predetermined reaction temperature range for a time sufficient for completion of a predetermined level of hydrolysis of polyacrylonitrile, wherein the reaction temperature (Tᵣ) is represented by the formula Tᵣ=Tₐ+Tₑ wherein Tₐ is the temperature resulting from the amount of added heat and Tₑ is the temperature increase from the heat generated by the exothermic reaction.

### CROSS REFERENCE TO RELATED APPLICATIONS

The present application claims the benefit and priority of provisional application Ser. No. 60/816,145 filed on Jun. 23, 2006 and titled PROCESS FOR MANUFACTURE HYDROGELS, the entire contents of which are hereby incorporated by reference.

### BACKGROUND

1. Technical Field

Manufacture of hydrogels.

2. Description of Related Art

Hydrogels are well-known and have been used in numerous and varied applications, e.g., contact lenses, surgical implants, toys and the like. They may be formed from various materials such as polyvinyl alcohol, methacrylates and polyacrylonitriles, to name a few. Polyacrylonitrile (PAN) polymers are used for fabrication of membranes, textile fibers, carbon fibers, or as engineering plastics. Their compositions vary widely from pure PAN homopolymer to copolymers of acrylonitrile (AN) with to about 20% molar of various comonomers. AN is typically combined either with hydrophilic co-monomers (such as acrylamide, vinyl pyrrolidone, styrene sulfonic acid, vinylsulfonic acid etc.) or with hydrophobic comonomers (such as alkyl acrylates or methacrylates, styrene, vinylchloride, methylstyrene, vinylpyrridine, etc.). Such copolymers are usually considered to be PAN as long as they still retain the main characteristics of PAN, namely, high crystallinity and high melting point in absence of PAN solvents. PAN is practically unmeltable because its melting temperature (theoretically over 320° C.) is higher than its decomposition temperature (PAN becomes discolored at temperatures above about 150° C. and above about 200° C. it turns into insoluble, non-meltable precursors of graphite.

A method for making PAN copolymer is described in U.S. Pat. No. 6,232,406 (the “'406 patent”), whose contents are incorporated by reference herein. Examples of PAN compositions and implants are described in U.S. Pat. Nos. 6,264,695 and 6,726,721, which are both incorporated by reference herein. Examples of suitable hydrogel forming copolymers are prepared by a partial alkaline hydrolysis of polyacrylonitrile (“HPAN”) in the presence of sodium thiocyanate (NaSCN). The resulting hydrolysis product is a multi-block acrylic copolymer, containing alternating hydrophilic and hydrophobic blocks. Hydrophilic blocks contain acrylic acid, acrylamidine, and acrylamide.

The '406 patent, at columns 9 and 10, indicates that, when producing PAN via a self-terminating reaction in a reaction vessel, an especially viscous intermediate formed during an exothermic reaction may lead to poor heat transfer. This, in turn, leads to uneven reaction temperature and the possibility that, in some parts of the reaction mixture, the temperature increases to a point where the reaction loses its self-terminating character. Additionally, the sequential distribution of reaction products is sensitive to reaction temperature since the initiation, propagation and termination reactions have different activation energies. Consequently, uneven temperature of reaction mixture leads to heterogeneity of the product. Therefore, it is important to control reaction temperature even if the reaction mixture is so viscous that it cannot be agitated. The solution to this problem is to cool the bulk of the viscous reaction mixture, i.e., as stated at column 10, lines 32 through 48, by inserting a tubular heat exchanger during the conversion step or by dividing the reaction mixture into multiple portions. As indicated in claim 1 of the '406 patent, step d.), the reaction mix is divided into a plurality of physical reaction compartments so as to increase outer surface area relative to volume as compared to outer surface area of a single reaction compartment to enhance cooling efficiency and to reduce undesirable center core thermal effects.

### SUMMARY

An improved method of making a PAN copolymer is provided which includes providing a first reaction mixture including polyacrylonitrile dissolved in an aqueous solution containing a thiocyanate salt; providing a second reaction mixture including a catalyst of the general formula MY wherein M is a metal selected from the group consisting of lithium, potassium and sodium and Y is an anion derived from a weak acid with pKa higher than about 5, dissolved in an aqueous reaction solvent containing a thiocyanate salt; mixing the first and second reaction mixtures in a container to form a master reaction mixture; heating the master reaction mixture via a heating element to maintain a predetermined reaction temperature range for a time sufficient for completion of a predetermined level of hydrolysis of polyacrylonitrile, wherein the reaction temperature (Tᵣ) is represented by the formula Tᵣ=Tₐ+Tₑ wherein Tₐ is the temperature resulting from the amount of added heat and Tₑ is the temperature increase from the heat generated by the exothermic reaction. In one embodiment, one or more heating elements are located in the interior of the container. In another embodiment, a source of heat is applied to the exterior of the container to heat portions of the reaction mixture located near the container walls, thereby maintaining a more substantially uniform temperature throughout the reaction mixture. In yet another embodiment, an internal heating element and an external heating element are used simultaneously. In a preferred embodiment, the resulting copolymer solution is substantially stable at ambient temperature.

### DESCRIPTION OF PREFERRED EMBODIMENTS

It has surprisingly been found that by not reducing the heat of the central core of a reaction mixture in the manufacture of a PAN copolymer of the type described in the '406 patent and, in contrast to the disclosure of the prior art, by adding heat to the reaction mixture, a more uniform temperature is maintained across the bulk of the reaction mixture, thereby resulting in a more uniform product. Reduction of heat in the central core area in accordance with the prior art results in a relatively cool central zone compared to surrounding areas where potential addition of external heat to initiate the reaction and the resulting exothermic reaction generates higher temperatures. The higher temperature areas support a faster rate of reaction resulting in uneven conversion rates. When the reaction mixture is heated in accordance with the present disclosure, it has now been found that the heat generated by the exothermic reaction is substantially uniformly distributed in the reaction mixture and increases the heated temperature of the mixture by about 2° C. to about 3° C. It is also surprising that when heat is added to the reaction mixture in accordance with the present disclosure, the heat generated by the exothermic reaction does not cause the temperature of the reaction mixture to exceed the limit necessary to maintain the self-terminating character of the reaction.

This disclosure involves a process of self-terminating hydrolysis of PAN that substantially eliminates heterogeneity of resulting copolymer and yields a substantially stable solution of copolymer that can be converted into shaped hydrogel articles by extrusion, casting, molding, dipping, spinning or similar shaping method combined with coagulation by an aqueous liquid. The conditions for the self-terminating PAN hydrolysis involve an alkali metal catalyst, referred herein as MY, in a specific molar ratio to CN groups in the 1,3 position on the PAN polymer backbone and the presence of sodium thiocyanate. In MY, M is a metal selected from the group consisting of lithium, potassium and sodium and Y is an anion derived from a weak acid with pKa higher than about 5. Examples of Y are OH⁻, SiO₂²⁻, CN⁻ or CO₃²⁻. Although MY is referred to as a catalyst herein due to its catalytic activity during the first phase of the hydrolysis reaction, it also functions as a consumable reagent during the second phase of the reaction. A preferred catalyst is NaOH. The self-termination of hydrolysis of acrylonitrile is achieved by neutralization of the strong base catalyst MY by weakly acidic groups formed by the reaction of CN groups in mutual 1,3 positions. CN groups in 1,3 positions are hydrolyzed.

The hydrolytic reaction includes at least two steps: 1) mixing a reaction mixture of at least two components A and B in a predetermined ratio, component A including dissolved PAN and component B including the MY catalyst, with both components including sodium thiocyanate and water; and 2) heating the mixture to a desired reaction temperature and maintaining such temperature for a time sufficient for completion of the reaction to a preselected conversion. As discussed in the '406 patent, there is a predictable and reproducible non-stoichiometric relation between product composition, molar ratio [MY]/[CN] and maximum reaction conversion for given reaction conditions. This allows for control of the end-point by using a predetermined specific value of [MY]/[CN] for each desired conversion. The constant of proportionality can be established by those skilled in the art for given reaction conditions such as temperature and solvent composition. There is no need to terminate the reaction by extraction or neutralization of the solvent and/or catalyst at a certain time because the reaction stops by itself (self-termination) once the catalyst is neutralized by the reaction product.

The reaction solvent should be a good solvent for PAN and the final product, and compatible with the catalyst. The solvent affects the reaction by affecting ionization of intermediates, carboxylate groups and catalyst. Unsuitably selected solvent may lead to an undesired polymer. A preferred solvent is an aqueous solution comprising sodium thiocyanate in concentration from about 45% to about 65% by weight and even more preferably from about 53% by weight to 57% by weight. A minor part of the sodium thiocyanate can be replaced by potassium, lithium or calcium thiocyanate without rendering the solvent inoperable. Generally, not more than about 33% by weight of sodium thiocyanate should be replaced for another thiocyanate. A minor part of water in the component A can be replaced by organic liquids, such as lower aliphatic alcohols C1 to C3, glycerol or ethylene glycol. Not more that about 25% by weight of water should be replaced by such organic liquids.

A preferred polymer configuration includes two polymer phases of different hydrophilicity, the less hydrophilic phase having higher content of hydrophobic groups and more hydrophilic phase having higher content of hydrophilic groups. The less hydrophilic phase is preferably crystalline and more hydrophilic phase is preferably amorphous, as can be established from X-ray diffraction.

Advantageous hydrophobic groups are pendant nitrile substituents in 1,3 positions on a polymethylene backbone, such as poly(acrylonitrile) or poly(methacrylonitrile). The hydrophilic phase may preferably contain a high concentration of ionic groups. Preferred hydrophilic groups are derivatives of acrylic acid and/or methacrylic acid including salts thereof, acrylamidine, N-substituted acrylamidine, acrylamide and N-substituted acryl amide, as well as various combinations thereof. A particularly preferred combination contains approximately one-half acrylic acid and its salts (on molar basis) in the hydrolyzed block, the rest being a combination of plain and N-substituted acrylamides and acrylamidines.

At least one polymeric component is preferably a multiblock copolymer with alternating sequences of hydrophilic and hydrophobic blocks. Such sequences are usually capable of separating into two polymer phases and form strong physically crosslinked hydrogels. Such multiblock copolymers can be, for example, products of hydrolysis or aminolysis of polyacrylonitrile or polymethacrylonitrile and copolymers thereof. For convenience, polymers and copolymers having at least about 80 molar % of acrylonitrile and/or methacrylonitrile units in their composition may also be referred to as “PAN”. Hydrolysis and aminolysis of PAN and products thereof are described, for example, in U.S. Pat. Nos. 4,107,121; 4,331,783; 4,337,327; 4,369,294; 4,370,451; 4,379,874; 4,420,589; 4,943,618, and 5,252,692, each being incorporated herein by reference in their respective entireties. Particularly preferred are associative polymers formed by hydrolysis and/or aminolysis of PAN to high but finite conversions that leave a certain number of nitrile groups (typically, between about 5 and 25 molar %) unreacted. Preferred composites have both a continuous phase and a dispersed phase formed by different products of hydrolysis or aminolysis of PAN. In this case, both components are compatible and their hydrophobic blocks can participate in the same crystalline domains. This improves anchorage of the more hydrophilic component and prevents its extraction or disassociation. The size of more hydrophilic domains may vary widely, from nanometers to millimeters, preferably from tens of nanometers to microns. The ratio between the continuous discrete phase (i.e., between more hydrophobic and more hydrophilic components may vary from about 1:2 to about 1:100 on a dry weight basis, and a preferred ratio ranges from about 1:5 to about 1:20.

Examples of particularly suitable hydrogel forming copolymers are prepared by a partial alkaline hydrolysis of polyacrylonitrile (“HPAN”) in the presence of sodium thiocyanate (NaSCN). The resulting hydrolysis product is a multi-block acrylic copolymer, containing alternating hydrophilic and hydrophobic blocks. Hydrophilic blocks contain acrylic acid, acrylamidine, and acrylamide. For example, a PAN hydrolyzate polymer (referred to herein as HPAN I) (46±1% conversion of hydrolysis) has the following composition: acrylonitrile units ˜53-55%, acrylic acid units ˜22-24%, acrylamide units ˜17-19%, acrylamidine units ˜4-6%, as determined by ¹³C NMR. Another example of a PAN hydrolyzate polymer, referred to herein as HPAN II (28±1% conversion of hydrolysis), has the following composition: acrylonitrile units ˜71-73%, acrylic acid units ˜13-15%, acrylamide units ˜10-12%, acrylamidine units ˜2-4%, as determined by ¹³C NMR.

In operation, the process for making copolymers herein can include the following steps:

1) PAN is dissolved in an aqueous inorganic solvent S containing sodium thiocyanate to form Solution A. The PAN concentration in the Solution A is denoted (C_{PAN,A}), in [% by weight];

2) Catalyst MY is dissolved in said solvent S to form Solution B. The MY concentration in the Solution B is denoted (C_{MY,B}), in [% by weight];

3) Solutions A and B are mixed in the weight ratio (A/B), at a temperature which avoids premature initiation of the reaction. For example, less than about 50° C., but preferably ambient temperature. The mixture is mixed for a sufficient time to adequately mix the solutions, e.g., 1 hour. Then the solution is heated to a temperature ranging from about 50° C. to about 100° C. The concentration of PAN in the reaction mixture C is (C_{PAN,C}) and concentration of the catalyst is (C_{MY,C}), both in [% by weight]. The molar ratio is:
[MY/PAN]=(MW_{PAN}/MW_{MY})*(C_{MY,C})/(C_{PAN,C})
where MW_{PAN} and MW_{MY} are molecular weights of PAN unit (53 Daltons for AN) and for the catalyst (40 for NaOH), respectively. The amounts of the Solutions A and B are selected to achieve a certain predetermined value of [MY]/[PAN];
4) Reaction temperature is increased to temperature Tᵣ[° C.] and maintained at that temperature for a reaction time tᵣ, e.g., about 24 hours to about 72 hours that is sufficient for the reaction to terminate (all MY is reacted); and,
5) Temperature is decreased to ambient temperature. The resulting casting solution may be kept in a closed container until processing into a hydrogel.

For the self-termination, it is advantageous to select reaction conditions such that ammonia and bases of equal or lower strength are not effective catalysts of the hydrolytic reaction. Namely, ammonia is being formed as a by-product of the above described hydrolytic reaction. If the newly formed ammonia were able to react with CN groups and/or to catalyze hydrolysis under the selected reaction conditions, then the reaction would not be self-terminating. The catalytic effectiveness of ammonia can be suppressed by carrying out the reaction in a solvent with high ionic strength and relatively low temperature. The solvent requirements are defined above. Reaction temperatures should be between about 40° C. and about 110° C., preferably between about 60° and about 80° C. Selection of reaction conditions is essential. It is known from the prior art that under different conditions, ammonia and even weaker bases are effective catalysts of PAN hydrolysis. Hydrolysis of CN catalyzed by ammonia would prevent the self-termination of the reaction.

In accordance with the present disclosure, it is advantageous to maintain a substantially uniform and constant temperature across the reaction mixture. As used herein, “substantially” is intended to mean any of “approximately”, “nearly” or “precisely.” If the temperature is variable, the initial higher temperature areas give rise to a more exothermic reaction, which causes the reaction to proceed at a faster rate in those areas. This causes more hydrolysis along the polymer chains resulting in an increased hydrolysis conversion in those areas. This adversely affects the mechanical properties, e.g., tensile strength, of a hydrogel article made from the copolymer since PAN blocks of irregular length are created, thus reducing cross-linking, i.e., well-developed crystallinity of PAN blocks.

In a preferred embodiment, solution A and solution B are kept at a desired temperature within the above preferred range, e.g., less than about 50° C. before they are combined in a reaction container. In this manner, the temperature of the reaction mixture is kept more constant. Heat is added to the reaction container containing the reaction mixture in any manner known to those skilled in the art that provides a substantially uniform delivery to a majority, if not all, the reaction mixture. For example, an internally disposed heating element can include one or more steel shafts, e.g., stainless steel, located in a central portion of the reaction container. The shaft(s) can be heated to any desired temperature within the suitable range described above, e.g., 70° C. Alternatively, a metal heating grid can be located within the reaction container and used as a heating element. The heating element can also be made of ceramic, or any other suitable material. It is also contemplated that an external heating element can be applied to the container. For example, a heating jacket made of a suitable heating element(s) can be wrapped around or otherwise envelop the container to direct heat to the container. Alternatively, the container can be situated in a fluid heat bath, e.g., oil or water bath. In addition, the container may be placed in an oven. In this manner, the walls of the container are kept at the desired temperature and do not serve to alter the temperature of the reaction mixture because they are not in contact with a lower temperature environment.

As mentioned above, the exothermic character of the reaction causes the predetermined temperature to rise between about 2° C. and about 3° C. during hydrolysis. Thus, the reaction temperature (Tᵣ) may be represented by the following formula: Tᵣ=Tₐ+Tₑ wherein Tₐ is the temperature resulting from the amount of added heat and Tₑ is the temperature increase from the heat generated by the exothermic reaction. For example, if the heating element(s) are set to 70° C., it has been found that the exothermic reaction takes the reaction mixture temperature up to about 72.5° C. If the heating element(s) are set to 75° C., it has been found that the exothermic reaction takes the reaction mixture temperature up to about 78° C. The reaction proceeds at a faster rate when higher temperatures are used.

By maintaining a substantially uniform and constant temperature across the reaction mixture, a more homogeneous copolymer is formed due to a uniform conversion of hydrolysis. In this manner, each polymeric chain in the mixture will undergo substantially the same amount of conversion leading to a uniform product. Accordingly, articles made using a copolymer made in accordance with the present disclosure will have a better degree of reproducibility, which is important for commercial manufacturing processes and government approval for marketing in the case of medical implants and/or devices.

The process and product properties can be further improved by elimination of oxygen and/or actinic light during the reaction and storage of the PAN copolymer solution. Presence of oxygen and light cause a certain discoloration of the product, probably by stabilizing certain intermediate chromophoric structures in the polymer. Nitrogen gas may be utilized during the reaction to eliminate contact with unwanted gases.

The following example is included here for purposes of illustrating one or more particular aspects of the subject matter disclosed herein. It should not be taken as the entire “invention” herein and is not meant to limit any claims herein in any manner whatsoever.

### EXAMPLE 1

### Preparation of HPAN-I

Solution A

220 g of PAN powder (220,000 Daltons) was placed into a 3 liter glass reactor (RMI reaction kettle). The PAN powder was premixed (manually) with 1613.33 g of 55% aqueous NaSCN (prepared from Aldrich 98% solid NaSCN). The reactor was sealed and flushed with nitrogen and then immersed into a preheated water bath (70° C.). The mixture, was stirred at 4.7 rpm. When the temperature reached 40° C., mixing increased to 10.8 rpm. The mixture was mixed at 70° C. and 10.8 rpm for 17 hrs and then cooled down to room temperature.

Solution B

A solution of 22.00 g of NaOH (mol. ratio NaOH/PAN 0.1325) in 589.11 g of 55% aqueous NaSCN was prepared at ambient temperature.

Reaction

Solution B was introduced through a SS316 capillary into the PAN solution (solution A) while mixing at 16.2 rpm. After 80 minutes of mixing, the speed was reduced to 10.8 rpm. The mixture was dark red 80 minutes after introduction of NaOH solution and stirring. The reactor kettle was immersed into a 70° C. water bath and stirring continued at 10.8 rpm until the mixture temperature reached 50° C. Mixing was then stopped and mixing shaft heating started at 70° C. The mixing shaft was attached to a heat source which caused the shaft to generate heat. Temperature was monitored from the start of NaOH solution addition. After 48 hours of heating (water bath and mixing/heating shaft at 70° C.) the mixture was stirred at 10.8 rpm speed for 1 hour (heat source removed) at the temperature of water bath (70° C.). The water bath was then removed and mixture transferred into a 3 liter polypropylene pressure vessel for further processing. To accelerate transfer, nitrogen pressure was increased in the reactor.

### EXAMPLE 2

### Preparation of HPAN-II

Solution A

220 g of PAN powder (220,000 Daltons) was placed into a 3 liter glass reactor (RMI reaction kettle). The PAN powder was premixed (manually) with 1613.33 g of 55% aqueous NaSCN (prepared from Aldrich 98% solid NaSCN). The reactor was sealed and flushed with nitrogen and then immersed into a preheated water bath (70° C.). The mixture was stirred at 4.7 rpm. When the temperature reached 40° C., mixing increased to 10.8 rpm. The mixture was mixed at 70° C. and 10.8 rpm for 17 hrs and then cooled down to room temperature.

Solution B

A solution of 11.00 g of NaOH (mol. ratio NaOH/PAN 0.0663) in 600.11 g of 55% aqueous NaSCN was prepared at ambient temperature.

Reaction

Solution B was introduced through a SS316 capillary into the PAN solution (solution A) while mixing at 16.2 rpm. After 80 minutes of mixing, the speed was reduced to 10.8 rpm. The mixture was dark red 80 minutes after introduction of NaOH solution and stirring. The reactor kettle was immersed into a 70° C. water bath and stirring continued at 10.8 rpm until the mixture temperature reached 50° C. Mixing was then stopped and mixing shaft heating started at 70° C. The mixing shaft was attached to a heat source which caused the shaft to generate heat. Temperature was monitored from the start of NaOH solution addition. After 48 hours of heating (water bath and mixing/heating shaft at 70° C.) the mixture was stirred at 10.8 rpm speed for 1 hour (heat source removed) at the temperature of water bath (70° C.). The water bath was then removed and mixture transferred into a 3 liter polypropylene pressure vessel for further processing.

It should be understood that the examples and embodiments of the subject matter provided herein are preferred embodiments. Various modifications may be made to these examples and embodiments without departing from the spirit and scope of the accompanying claims. For example, those skilled in the art may envision additional polymers, materials and/or hydrogels not mentioned herein which can be utilized in accordance with the principles described herein.

What is claimed is:

1. A method of making a polyacrylonitrile copolymer including providing a first reaction mixture including polyacrylonitrile dissolved in an aqueous solution containing thiocyanate salt; providing a second reaction mixture including a catalyst of the general formula MY wherein M is a metal selected from the group consisting of lithium, potassium and sodium and Y is an anion derived from a weak acid with pKa higher than about 5, dissolved in an aqueous reaction solvent containing a thiocyanate salt; mixing the first and second reaction mixtures in a container to form a master reaction mixture; heating the master reaction mixture via a heating element to maintain a reaction temperature range for a time sufficient for completion of a predetermined level of hydrolysis of polyacrylonitrile, wherein the reaction temperature (Tᵣ) is represented by Tᵣ=Tₐ+Tₑ wherein Tₐ is the temperature resulting from the amount of added heat and Tₑ is the temperature increase from the heat generated by the exothermic reaction.

2. A method of making a polyacrylonitrile copolymer according to claim 1 wherein the resulting copolymer is substantially stable at ambient temperature.

3. A method of making a polyacrylonitrile copolymer according to claim 1 wherein the heating element is disposed within the container.

4. A method of making a polyacrylonitrile copolymer according to claim 3 wherein the heating element is a shaft.

5. A method of making a polyacrylonitrile copolymer according to claim 4 wherein the shaft is disposed in a central portion of the container.

6. A method of making a polyacrylonitrile copolymer according to claim 3 wherein the shaft is made of stainless steel.

7. A method of making a polyacrylonitrile copolymer according to claim 3 wherein the heating element is made of ceramic.

8. A method of making a polyacrylonitrile copolymer according to claim 3 wherein the heating element is a grid.

9. A method of making a polyacrylonitrile copolymer according to claim 1 wherein the heating element is disposed outside the container and is capable of directing heat to the container.

10. A method of making a polyacrylonitrile copolymer according to claim 9 wherein the heating element is a jacket that surrounds the container.

11. A method of making a polyacrylonitrile copolymer according to claim 9 wherein the heating element is an oven adapted to receive the container.

12. A method of making a polyacrylonitrile copolymer according to claim 9 wherein the heating element is a heated fluid bath adapted to receive the container.

13. A method of making a polyacrylonitrile copolymer according to claim 1 wherein the heating element comprises one or more internal and one or more external heating members, the internal heating member(s) being disposed within the container, the external heating(s) member being disposed outside the container, the external heating member(s) being capable of directing heat to the container.

14. A method of making a polyacrylonitrile copolymer according to claim 13 wherein the internal heating member is selected from the group consisting of shaft and grid.

15. A method of making a polyacrylonitrile copolymer according to claim 13 wherein the external heating member is selected from the group consisting of jacket, heated fluid bath and oven.

16. A method of making a polyacrylonitrile copolymer according to claim 1 wherein the copolymer has a multiblock structure comprising acrylic acid, acryl amide and acrylamidine hydrophillic groups in hydrophillic blocks and residual nitrile groups in hydrophobic blocks.

17. A method of making a polyacrylonitrile copolymer according to claim 1 wherein the temperature range is between about 40° C. and about 110° C.

18. A method of making a polyacrylonitrile copolymer according to claim 1 wherein the temperature range is sufficient to cause temporary solidification of the reaction mixture.

19. A method of making a polyacrylonitrile copolymer according to claim 1 wherein the first reaction mixture and second reaction mixture are each brought to a temperature ranging from about 40° C. and about 110° C. prior to being mixed together.

20. A method of making a polyacrylonitrile copolymer according to claim 1 wherein the hydrolysis is carried out in the absence of oxygen.

21. A method of making a polyacrylonitrile copolymer according to claim 1 wherein MY is a metal compound catalyst wherein Y is selected from the group consisting of OH⁻, SiO₂²⁻, CN and CO₃²⁻.

22. A method of making a polyacrylonitrile copolymer according to claim 1 wherein MY is NaOH.

23. A method of making a polyacrylonitrile copolymer according to claim 1 wherein MY has a predetermined molar ratio [MY]/[CN] in said master reaction mixture wherein [MY] represents molar concentration of MY and [CN] represents molar concentration of pendent CN groups of the polyacrylonitrile in 1, 3 positions.

24. A method of making a polyacrylonitrile copolymer according to claim 1 wherein the thiocyanate salt has a concentration in said master reaction mixture of about 45% to about 65% by weight, based on the weight of thiocyanate salt and the weight of the water.

25. A method of making a polyacrylonitrile copolymer according to claim 1 wherein the thiocyanate salt is sodium thiocyanate.

26. A method of making a polyacrylonitrile copolymer according to claim 25 wherein a thiocyanate selected from the group consisting of potassium thiocyanate, lithium thiocyanate and calcium thiocyanate is also included in said master reaction mixture in a minority amount relative to said sodium thiocyanate.

27. A method of making a polyacrylonitrile copolymer according to claim 1 wherein the polyacrylonitrile copolymer is formed into a shaped hydrogel article.

28. A method of making a polyacrylonitrile copolymer according to claim 1 wherein the shaped hydrogel article is a spinal nucleus implant.

29. A method of making a polyacrylonitrile copolymer according to claim 1 wherein the first reaction mixture and second reaction mixture are each maintained at ambient temperature prior to being mixed together.
